(19) United States
(12) Patent Application Publication
(10) Pub. No.: US 2006/0025907 A9
(43) Pub. Date: Feb. 2, 2006

(54) Vehicle-interactive system

(75) Inventors: Michael Kapolka, Sterling Heights, MI (US); Sam Chang, West Bloomfield, MI (US); Andrew Smith, Cedar Rapids, IA (US); Brian Crull, Clarkston, MI (US); Dennis Essenmacher, Royal Oak, MI (US); Tracy Meade, Attica, MI (US); Rebecca Lohr, Cedar Rapids, IA (US); Gregory A. Dils, Tiffin, IA (US); Machlab El-Hajj, Coralville, IA (US); Nik Neymeyer, Marion, IA (US); Kevin Williams, Clarkston, MI (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: NNT, Inc., Auburn Hills, MI (US)

(21) Appl. No.: 10/823,271

(22) Filed: Apr. 12, 2004

Related U.S. Application Data
(63) Continuation-in-part of application No. 10/358,637, filed on Feb. 5, 2003, now abandoned.
(63) Continuation-in-part of application No. 10/091,096, filed on Mar. 4, 2002.
Application No. 10/091,096 is a continuation-in-part of application No. 09/640,785, filed on Aug. 18, 2000.
(60) Provisional application No. 60/462,561, filed on Apr. 11, 2003.
(60) Provisional application No. 60/462,582, filed on Apr. 11, 2003.
(60) Provisional application No. 60/462,583, filed on Apr. 11, 2003.
(60) Provisional application No. 60/354,673, filed on Feb. 5, 2002.

(51) Int. Cl. G05D 1/00

(52) U.S. Cl. 701/29; 701/1

(57) ABSTRACT

A vehicle information system including a computing system, a vehicle application, an access-layer application, a vehicle-application database, and a communication adapter is provided. The computing system may run an operating system and a plurality of applications. The vehicle application, which is executable by the computing system, may provide policy processing of a parameter received from the access-layer application. The access-layer application has a first interface adapted to communicate with the vehicle application and a second interface adapted to communicate with the operating system. The vehicle-application database may house information for processing the parameter. The communication adapter may pass the at least one parameter between the second interface and the vehicle controller. The access-layer application is operable obtain the information from the vehicle-application database, and to process the parameter as a function of the information so as to pass the processed parameter between the first and second interfaces.

### CROSS-REFERENCE TO RELATED APPLICATIONS

The present application is a continuation-in-part, claiming the benefit of commonly assigned, co-pending U.S. patent application Ser. No. 10/358,637, filed Feb. 5, 2003, entitled “Vehicle Interactive System,” which claims the benefit of U.S. Provisional Application No. 60/354,673, filed Feb. 5, 2002, entitled “Vehicle-Interactive System,” filed Feb. 5, 2002, the disclosures of which are incorporated by reference in their entirety.

This application also claims the benefit of (i) U.S. Provisional Patent App. Ser. No. 60/462,561, filed Apr. 11, 2003, entitled “System, Method and Computer Program Product for Remote Vehicle Diagnostics, Telematics, Monitoring, Configuring, and Reprogramming,” (ii) U.S. Provisional Application No. 60/462,582, entitled “Wireless Communication Framework”, filed Apr. 11, 2003, and (iii) U.S. Provisional Application No. 60/462,583 (Attorney Docket No. 03-050-D), entitled “Vehicle Interactive System”, filed Apr. 11, 2003., the disclosures of which are incorporated by reference in their entirety.

The following related applications are hereby incorporated herein by reference in their entirety:
U.S. Utility application Ser. No. 10/091,096, filed Mar. 4, 2002, entitled “Remote Monitoring, Configuring, Programming and Diagnostic System and Method for Vehicles and Vehicle Components;”
U.S. Utility application Ser. No. 09/640,785, filed Mar. 4, 2002, entitled “System, Method, and Computer Program Product for Remote Vehicle Diagnostics, Monitoring, Configuring and Reprogramming;”
U.S. Utility application Ser. No. 10/084,800, filed Feb. 27, 2002, entitled “Vehicle Telemetry System and Method;”
U.S. Utility application Ser. No. 10/229,757, filed Aug. 28, 2002, entitled “Remote Vehicle Security System;
U.S. Utility application Ser. No. ______ (Attorney Docket No. 03-089-01), entitled “System, Method and Computer Program Product for Remote Vehicle Diagnostics, Telematics, Monitoring, Configuring, and Reprogramming,” filed concurrently herewith; and
U.S. Utility application Ser. No. ______ (Attorney Docket No. 03-78-A1), entitled “Wireless Communication Framework,” filed concurrently herewith.

### TECHNICAL FIELD

The following relates generally to a vehicle-interactive system, and more particularly, to an extended-vehicle-data-system framework for extending vehicle diagnostic and telematic information for the vehicle-interactive systems. The extended-vehicle-data-system framework is particularly useful for providing an efficient, portable, reliable and extensible standard infrastructure for creating cross-platform, vehicle-interactive applications without locking into a single protocol, platform or communication system.

### BACKGROUND

It is common for companies to own large numbers or fleets of commercial motor vehicles. Typical examples of such companies include commercial courier services, moving companies, freight and trucking companies, truck leasing companies, as well as passenger vehicle leasing companies and passenger couriers. To maintain profitability, a company owning a vehicle fleet ideally minimizes the time spent in vehicle maintenance and repair. Maintaining optimum vehicle performance often involves removing vehicles from service to conduct fault analysis, schedule maintenance, diagnostics monitoring and parameter modifications.

To facilitate this objective, many companies implement on-board vehicle systems to maintain current information on the vehicle and to implement program level changes in various components of the vehicle. In general, these vehicle systems facilitate data or information transfer between the on-board vehicle systems and a vehicle diagnostic system. Traditional vehicle diagnostics systems have taken two major forms. The first of these includes very limited in-vehicle diagnostics displays (such as oil-pressure gauges and “check engine” indicators). And the second includes comprehensive service-bay scan tools in the form of handheld diagnostic devices or diagnostics software for personal computers. Each form serves a very specific audience. The former notifies the driver of serious problems, while the latter enables service technicians to diagnose and repair problems indicated by the vehicle's electronic control modules. While these systems function well, they have operational limits that can result in extra cost and downtime for the vehicle. For example, the in-vehicle diagnostics displays often reveal problems only after they have become serious, while there may have been early indications of a problem forming that could have been revealed by more sophisticated tools.

Generally, the vehicle diagnostic systems have a central computer system that communicates with the on-board vehicle systems. The central computer system typically receives data from and/or sends data to the on-board vehicle system through the central computer, which in turn, communicates with a user through a user device such as personal computer, personal digital assistant (PDA), or other electronic device. Various vehicle systems can be used to communicate various types of information, such as vehicle security information, vehicle position/location, driver trip information, jurisdiction boundary crossing information, fuel consumption information, driver messaging, concierge services, and information relating to local and remote diagnostics, such as monitoring the wear and tear of the vehicle and its various components, among others.

While these vehicle diagnostic systems provide a centrally located method for communicating with and maintaining centralized records of activities of a vehicle, some drawbacks exist. Specifically, many different types of software platforms may be used on the centrally located computer, the user device, and/or the vehicle system. Further, each of the vehicle diagnostic systems is typically written in proprietary and non-standard, customized software around a specific vehicle communications protocol (e.g., J1708, J1939, CAN, CANII, and etc). As on-board vehicle systems and communications protocols proliferate and change, the design and development life-cycle of vehicle-interaction applications begins anew, many times creating and recreating non extensible and non-scalable software. These proprietary and non-standard customized software applications suffer from not being able to support (i) more than one type of platform, (ii) standard operating systems, (iii) widely used embedded computers, Windows portable devices, and PalmOS devices, and (iv) other standardized frameworks

Further, the on-board vehicle systems may include more than one vehicle controller. These vehicle controllers may or may not communicate according to the same protocol. Thus, different customized software applications may be needed to communicate with each of vehicle controllers when a single vehicle protocol may not be sufficient. In addition to the cost of such additional applications, customers may have to pay for the incremental cost of the vehicle information system's users (typically a service station or other attendant) time for switching between applications for each of the differing vehicle controllers. As the number of vehicle controllers and the wage of a user increases, this incremental cost may be quite substantial.

Moreover, because the customized software applications are generally written for specific platforms, its functionality is generally concentrated on a single platform. As such, legacy systems provided customized solutions for each specific software platform used on the mobile unit or central computer, which has resulted in many legacy systems being locked into a single comprehensive, non-distributed and non-scalable customized solution as the difficulty of accommodating all applications and networks is difficult. The following was developed in light of these and other drawbacks.

### SUMMARY

Accordingly, presented is a vehicle information system (VIS) and method for providing an efficient, portable, reliable and extensible standard infrastructure for creating cross-platform, vehicle-interactive applications without locking into a particular protocol, platform or communication system. The VIS includes a computing system, one or more vehicle applications, an access-layer application, a vehicle-application database, and a communication adapter.

The computing system may be adapted to run an operating system and a plurality of applications. The vehicle applications, which are executable by the computing system, may be operable to provide policy processing of at least one parameter received from the access-layer application. The access-layer application, which is also executable by the computing system, has a first interface adapted to communicate with the vehicle application and a second interface adapted to communicate with the operating system. The vehicle-application database is operable to house information for processing the parameter, which is passed between first and second interfaces. The communication adapter is operable to pass the at least one parameter between the second interface and the vehicle controller. The access-layer application is operable obtain from the vehicle-application database the information, and to process the parameter as a function of the information so as to pass the processed at least one parameter between the first and second interfaces in a form commensurate with the first and second interfaces.

In addition, layered in between the first and second interfaces may be one or more functional modules that provide the functionality that may relieve the application developer from writing operating-system specific, protocol specific, communication specific, on-board vehicle system specific, and other non-vehicle application type code.

### BRIEF DESCRIPTION OF THE DRAWINGS

Exemplary embodiments are described below in conjunction with the appended drawing figures, wherein like reference numerals refer to like elements in the various figures, and wherein:

FIG. 1 illustrates an exemplary enterprise infrastructure of a Vehicle Diagnostic and Information System for a vehicle-information system in accordance with an exemplary embodiment;

FIG. 2 illustrates a vehicle-interactive system having an extending vehicle-data-system framework in accordance with an exemplary embodiment; and

FIG. 3 illustrates an exemplary architecture of the vehicle-data-system framework in accordance with an exemplary embodiment.

### DETAILED DESCRIPTION

Enterprise-wide systems for such needs as tracking fleets, scheduling pickup and delivery, or monitoring fuel and repair costs are widely used by major commercial shipping firms. Establishing an infrastructure for vehicle information provides value in several ways: the OEM can provide rapid diagnosis of vehicle problems; leasing companies are able to ensure that their vehicles are within contracted use and can respond quickly to equipment problems; and fleets can combine driver support, reward programs, and other enterprise-wide cost-control measures with constant on-the-road feedback.

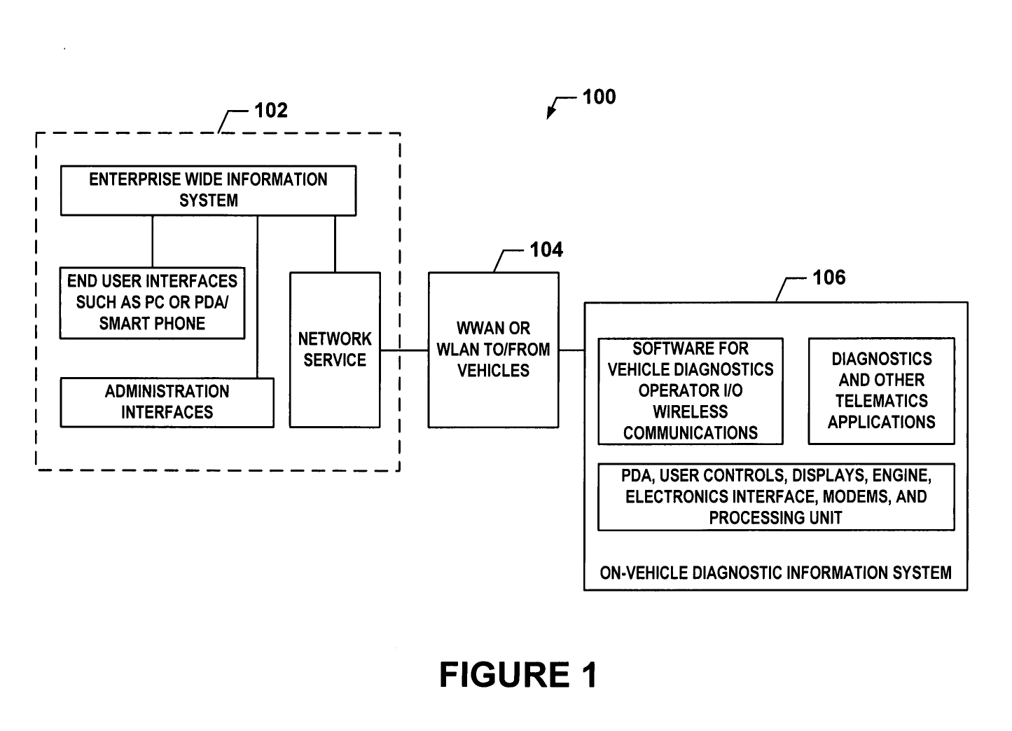

FIG. 1 illustrates an exemplary enterprise infrastructure of a Vehicle Diagnostic and Information System (VDIS) 100 for a vehicle-information system. The enterprise infrastructure includes at least an off-vehicle system 102, a communications system 104, and an on-vehicle diagnostic system 106.

The VDIS 100 may (i) prioritize and present diagnostics or logistics information to the vehicle operator; (ii) interact with an operator as he/she analyzes the vehicle condition or runs other telematics applications; (iii) provide wireless download of new subsystem functions and field upgrades; (iv) transmit vehicle information between itself and an enterprise information system, (v) react to updates of vehicle parameters from the enterprise information system; (vi) maintain security over accessing vehicle diagnostic and information systems, and (vii) execute other vehicle diagnostic and telematic operations.

The VDIS 100 may include a plurality of software frameworks including (i) an extended vehicle data system (xVDS), which may provide for passing parameters to and from onboard vehicle systems that interface with vehicle subsystems; (ii) an in-vehicle graphical interface system, which may prioritize data in a user-optimized fashion and often presents information through graphical displays, gauges, buttons, and indicators; and (iii) a communication framework (CF), which may allow for cost-effective use of multiple (wired or wireless) communication services via the communications system 104.

The VDIS 100 may reduce the cost of on-board software development and maintenance. The software architecture of the VDIS 100 can minimize the engineering time for many likely changes in areas such as on-vehicle hardware and driver interface presentation. This type of architecture may be integrated into the software frameworks, allowing each framework to be upgradeable without affecting the other ones.

The xVDS provides a standard infrastructure or framework for creating vehicle-interactive applications, without locking the system into any specific protocol, platform, or communication system. The xVDS may include a data-driven framework. And functionality to support vehicle-interactive applications may be implemented using the framework of the xVDS to act upon a vehicle data store, such as a database. The xVDS framework may relieve an application developer of writing code for a specific protocol, platform and/or communication system.

The framework of the xVDS may be cross-platform, thereby providing the same services on differing platforms. This framework may also be ported to new platforms, abstracting operating system and hardware dependencies.

The framework may include one or more functional modules, which allow the addition of new algorithms or removal of other functionality based on the desired behavior of the vehicle-interaction system. By allowing such scaling, the functional modules may allow for full customization of the vehicle-interactive application without the cost of writing and re-writing custom code.

In the following detailed description, numerous specific details are set forth in order to provide a thorough understanding of exemplary embodiments described herein. However, it will be understood that these embodiments may be practiced without the specific details. In other instances, well-known methods, procedures, components and circuits have not been described in detail, so as not to obscure the following description. Further, the embodiments disclosed are for exemplary purposes only and other embodiments may be employed in lieu of or in combination with of the embodiments disclosed.

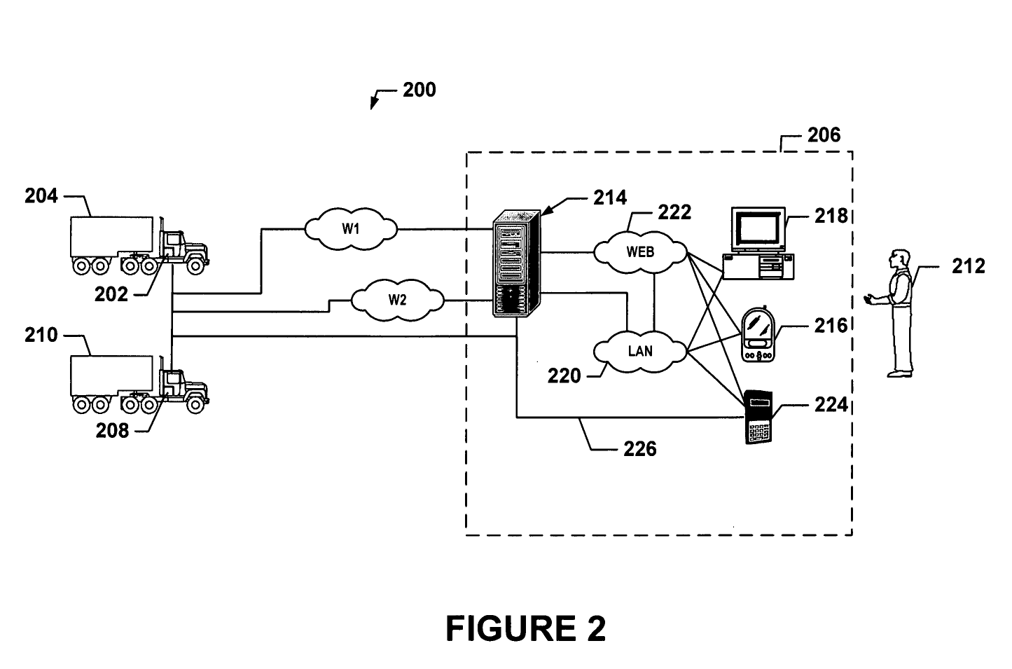

Referring now to FIG. 2, a vehicle-interactive system 200 is shown that includes an xVDS framework in accordance with an exemplary embodiment. The vehicle-interactive system 200 includes an onboard vehicle system 202 positioned on a vehicle 204. The on-board vehicle system 202 may include one or more vehicle controllers, such as an electronic control unit, a body controller, an anti-lock brake unit, a steering controller, a trailer controller, a trailer brake controller, a refrigeration controller, and others. These vehicle controllers may be positioned within various areas of the vehicle 204.

A computing system 206 may communicate with on-board vehicle system 202 through any one of a plurality of communication networks; two of which are illustrated in FIG. 1 as W1 and W2. Similarly, on-board vehicle system 208 of vehicle 210 may communicate with the computing system 206 through networks W1 and/or W2. The W1 and/or W2 networks may represent any terrestrial or satellite, wired or wireless network. Alternatively, computing system 206 may communicate with on-board vehicle systems 202, 208 via a tethered connection 226. This tethered connection 226 may be, for example, a direct connection or a series of connections that ultimately connect the computing system 206 with onboard vehicle systems 202, 208. The tethered connection 226 may be a serial or parallel type connection according to standard or proprietary configuration, such as Universal Serial Bus (USB), RS-232, parallel port, IEEE 1284, IEEE 1394, IEEE 488, and others. Communications transmitted over these connections may conform to one or more standard and/or proprietary protocols.

A user 212 desirous of effectuating communication with any of the on-board vehicle systems 202, 208 may accomplish this by communicating using the computing system 206. The computing system 206 may include one or more computers or other processing hardware, such as host computer 214, PDA 216, computer 218, and scan-tool device 224. As such, the communication with the on-board vehicle systems 202, 208 may be achieved using any of the host computers 214, PDA 216, computer 218, and/or scan-tool device 224 alone or combined. In one exemplary embodiment, any of the host computer 214, PDA 216, computer 218, and/or scan-tool device 224 may connect via the tethered connection 226. In another exemplary embodiment, the communication may be achieved using the PDA 216, computer 218, and/or scan-tool device 224 via the host computer 214.

The host computer 214 may be a fixed-based server system that can access the Internet 36, a satellite network, a local area network (LAN) 34, networks W1 and W2, tethered connection 226, and any other land-based or wireless connection systems. The host system 214 may exchange data and other information with the onboard vehicle systems 202, 208. The host computer 214 may also act as a portal for a user 212 to access on-board vehicle systems 202, 208 to retrieve and send data and information.

The computing system 206 also may contain at least one application program for running business applications related to user activities, which may include performing business logic, interfacing to the systems databases for fleet, vehicle, component and track transaction activity; conducting knowledge-base storage; and sending user-requested vehicle queries or functions to remote vehicles, such as vehicles 204, 210. These applications can be concentrated on the any of computers within the computing system 206, such as host computer 214. Alternatively, these applications may be distributed among the computers within the computing system 206. These applications may be contained on a separate computer system (not shown) as well.

As noted, user 212 may interface with the computing system 206 using a mobile or PDA device 216 computer 218 and/or scan-tool device 224. The access devices may contain one or more software applications to process information relating to onboard vehicle systems 202, 208 received from host computer system 214 and/or the on-board vehicle systems 202, 208. These devices, via the software applications, may exchange data and other information with the on-board vehicle systems 202, 208 directly or via host system 214. The PDA device 216, computer 218, and/or scan-tool device 224 may link to the host computer 214 by any of a plurality of known network models. For example, the PDA device 216, computer 218, and/or scan-tool device 224 may communicate with host computer 214 through local area network (LAN) 220 or the Internet 222. It is understood that other network models and corresponding devices may be used to communicate and transfer electronic information between user 212, host computer 214, and the on-board vehicle systems 202, 208.

Vehicles 204, 210 may be components of a fleet and may also be cars, boats, planes, any other known vehicle, and/or any other device having a diagnostic link. As depicted in the exemplary embodiment shown in FIG. 2, vehicles 204, 210 are trucks, which may be part of a commercial trucking fleet.

Onboard vehicle systems 202, 208 may communicate with computing system 206 via W1 or W2, which can be any of a number of known terrestrial or satellite networks. As such, the host computer 214 may communicate with a number of different onboard vehicle systems 202, 208 using any of a number of different network systems.

On-board vehicle systems 202, 208 may be linked to a plurality of sensors and other devices, such as antilock-brake controllers and/or body controllers. The sensors and other devices maybe logically positioned throughout the vehicles 204, 210. The sensors and other devices may send, receive, and gather various types of information such as vehicle mileage, maintenance scheduling, location, and other important information that the user 212 may want to access through host computer 214. The vehicles 204, 210 may be provided with real time computing for processing system information and gathered data from the plurality of sensors and other devices. This processing may include data-stream processing, discrete measurement gathering, vehicle position information, wireless communications through the W1 and/or W2 networks, and real time analysis of data.

On-board vehicle systems 202, 208 can act as vehicle servers, providing vehicle specific data and functionality in response to client requests. On-board vehicle systems 202, 208 may also include one or more vehicle data gateways for communicating with one or more of the vehicle controllers. These systems may be expandable or extended using xVDS framework as described in more detail below.

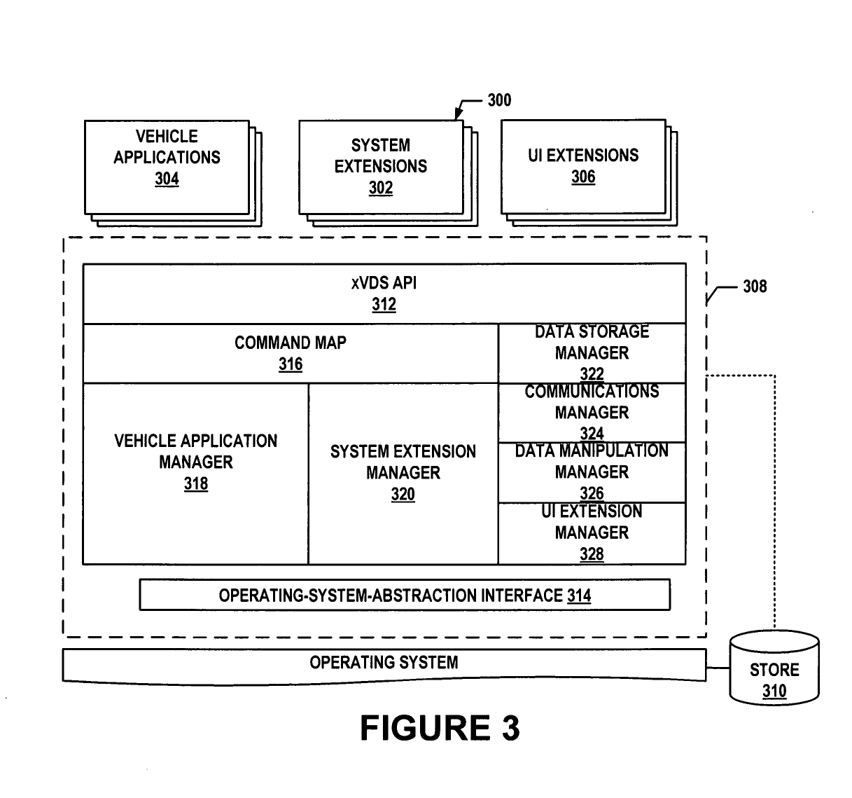

FIG. 3 illustrates an exemplary architecture of the xVDS framework 300. The xVDS framework 300 may be concentrated on one of the computers of the computing system 206, such as the host computer 214 or the computer 218. Alternatively, the xVDS framework 300 may be distributed among the computing system 206, the on-board vehicle systems 202 or 208, and data store 310. In any case, the computing system 206 is adapted to run an operating system and a plurality of applications. As noted above, the computing system 206 may be any of a plurality of hardware platforms, and thus, may be adapted to run one or more of a plurality of standard and/or proprietary operating systems.

An operating system typically resides in a part of a memory of the computing system 206 known as the operating system or kernel space. The core of the operating system, which is generally referred to as kernel code, handles matters such as process scheduling, memory management, hardware communication and network traffic processing. Applications, which are made of application code, are stored in a separate portion of memory. In operation, the kernel code and application code are maintained in separate portions of memory and are each executed by the computer processor (or multiple processors). Thus, the kernel code is said to be running in “kernel space,” and application code is said to be running in application or “user space.” Applications, however, may use the kernel code to access system resources and hardware through system calls, and are therefore thought of as running above, or on top of, the kernel.

The xVDS framework 300 may include one or more system extensions 302, one or more vehicle applications 304, one or more user interface extensions 306, and an access-layer application 308. The system extensions 302 may provide a standardize method for adding or removing functionality of the xVDS framework 300, such as supplying communication protocols for accessing one or more of the vehicle controllers. The system extensions 302 may provide this functionality without modifying the operating system and/or the computing system 206. Using the system extensions 302 allows the xVDS framework 300 to be scalable, distributable, and portable.

The system extensions 302 may reside in the application space when loaded in memory or stored in a data store of the computing system 206, such as a disk drive and/or other mass storage media (not shown), when inactive. The system extensions 302 may be deployed as dynamic link libraries (DLLs) and/or shared libraries if the computing platform of the computing system 206 supports them. Alternatively, the system extensions 302 may be deployed as statically-linked libraries. The system extensions 302 may take other forms as well.

When needed, the system extensions 302 may be called by the access-layer application 308 and loaded into memory of the computing system to provide the additional functionality. The system extensions 302 may be written so that their functionality is shared by more than one application (e.g., vehicle applications 304) at the same time (i.e., reentrant code).

The vehicle applications 304 may contain functionality for the policy processing of one or more parameters, such as diagnostic and/or telematic data and/or software routines, which may be passed between the vehicle applications 304 and the onboard vehicle systems 202, 208. The policy processing may include business logic, business measures, look-up rules, value driven and cosmetic modifications, data resolution, analytics, presentation, component and track transaction activity for specific vehicles and fleets; knowledge-base generation and storage, user-requested vehicle queries or functions to remote vehicles, such as vehicles 204, 210, and other policy-based decision criterion.

The vehicle applications 304 may reside in the application space when loaded in memory or stored in a data store of the computing system 206, such as a disk drive and/or other mass storage media (not shown), when inactive. The vehicle applications 304 may be deployed as stand-alone executable programs, one or more dynamic link libraries and/or shared libraries if the computing platform of the computing system 206 supports them. Alternatively, the system extensions 302 may be deployed as statically-linked libraries. The vehicle applications 304 may take other forms as well

Alternatively, the vehicle applications 304 may be incorporated into or otherwise distributed among a vehicle data store, such as database 310, and the application code of the vehicle applications 304. This distributed code may work within the xVDS framework 300 to form a complete application. The data store may be concentrated or distributed among the computing system 206, the onboard vehicle systems 202 or 208, and/or an external mass storage device (not shown). The vehicle database 310, which may be coupled to the computing system 206 and/or the on-board vehicle systems 202, 208, may house the at least one parameter passed between the vehicle applications 304 and the on-board vehicle systems 202, 208

When activated (thorough, e.g., some data-driven automation or interaction with user 212), the vehicle applications 304 interface with the access-layer application 308 and are loaded into memory of the computing system 206 to provide the desired functionality. The vehicle applications 304 may be written so that their functionality is reentrant-type code.

The user interface extensions 306, like the system extensions 302, may provide a standard method for adding or removing user-interface functionality of the xVDS framework 30 to take input from and display results on a variety of computing platforms. The user interface extensions 306 may provide this functionality without modifying the operating system and/or the computing system 206. Using the user interface extensions 306 allows the xVDS framework 300 to be scalable, distributable, and portable.

The user interface extensions 306 may reside in the application space when loaded in memory or stored in a data store of the computing system 206, such as a disk drive and/or other mass storage media (not shown), when inactive. The user interface extensions 306 may be deployed as dynamic link libraries (DLLs) and/or shared libraries if the computing platform of the computing system 206 supports them. Alternatively, the user interface extensions 306 may be deployed as statically-linked libraries. The user interface extensions 306 may take other forms as well.

When porting the xVDS framework 300 to differing computing platforms, the user interface extensions 306 directed to the appropriate computing platform may be called by the access-layer application 308 and loaded into memory of the computing system to provide the user interface. The user interface extensions 306 may be written so that their functionality is reentrant.

The access-layer application 308 may be an intermediary application that is operable to pass one or more parameters, such as diagnostic and/or telematic data and/or software code, between the vehicle applications 302 and the on-board vehicle systems 202, 208. The access-layer application 308 may reside in the application space and be transparent to the user 212. For instance, the access-layer application 308 may loaded into memory at initialization with the operating system and invoked in response to running one or more of the vehicle applications. Alternatively, the access-layer application 308 may be loaded into memory and invoked in response to running one or more of the vehicle applications 304. In yet another alternative, the access-layer application 308 may be loaded into memory and invoked through some data-driven automation or user interaction.

The access-layer application 308 may be deployed as one or more stand-alone program, dynamic link libraries (DLLs) and/or shared libraries if the computing platform of the computing system 206 supports them. Alternatively, access-layer application 308 may be deployed as statically-linked libraries. The access-layer application 308 may take other forms as well.

To pass parameters such as diagnostic and/or telematic data and/or software code between the vehicle applications 302 and the on-board vehicle systems 202, 208, the access-layer application 308 may include at least a first interface to communicate with the vehicle applications 304 and a second interface to communicate with the operating system. The first interface may be deployed as an xVDS application program interface (API) 312. The second interface may be deployed as an operating-system-abstraction interface 314.

Layered in between the first and second interfaces may be one or more functional modules that provide the functionality that may relieve the application developer from writing operating-system specific, protocol specific, communication specific, on-board vehicle system specific, and other non-vehicle application type code. As part of the access-layer application 308, these functional modules may be deployed as any of the stand-alone programs, dynamic link libraries and/or shared libraries, statically-linked libraries, and other equivalent programming structure. The functional modules may include a command map 316, a vehicle application manager 318, a system extension manager 320, a data storage manager 322, a communications manager 324, a data manipulation manager 326, and a user-interface manager 328. Other modules may be included as well.

The xVDS API 312 may provide a standard interface that allows the vehicle applications 304 and system extensions 302 use of the xVDS framework 300. Through function calls to the underlying functional modules, the xVDS API 312 may be used by the vehicle applications 304 and system extensions 302 to communicate with the on-board vehicle systems 202, 208 via the operating system. For example, when one of the vehicle applications 304 desires to retrieve data from the on-board vehicle system 202, the xVDS API 312 may receive one or more requests from the vehicle application to perform the retrieval. Though one or a series of function calls to the underlying modules, such as the communication manager 324, a communication may be set-up between the vehicle application and the on-board vehicle system 202.

Similar to the xVDS API 312, the operating-system-abstraction interface 314 interfaces with the overlying functional modules and the underlying operating system. The operating-system-abstraction interface 314 may allow for easy porting of the xVDS framework 300 to a plurality of different platforms by abstracting operating system and hardware dependencies and configurations from the underlying operating system. An exemplary operating-system-abstraction interface 314 may be deployed as an operating system “thin layer,” which may isolate the xVDS framework 300 from operating system and platform differences.

Through function calls from the overlying functional modules, the operating-system-abstraction interface 314 interfaces with the underlying operating system to connect the vehicle applications 304 and system extensions 302 with the onboard vehicle systems 202, 208. Continuing with the example above, when one of the vehicle applications 304 desires to retrieve data from the on-board vehicle system 202, the operating-system-abstraction interface 314 may receive one or more function calls from one or more of the overlying functional modules, such as the communication manager 324, to set-up and connect the vehicle application to the on-board vehicle system 202 to perform the retrieval. After abstracting the operating system attributes, if any, the operating-system-abstraction interface 314, though one or a series of function calls to the underlying operating system, provides a communication connection for the vehicle application 304.

Being part of the access-layer application 308, the xVDS API 312 and the operating-system-abstraction interface 314 may be deployed as any of the stand-alone programs, dynamic link libraries and/or shared libraries, statically-linked libraries, and other equivalent programming structure. Like the rest of the access-layer application 308, the xVDS API 312, the operating-system-abstraction interface 314, and the functional modules may be concentrated on a single computer within the computing system 206, or may be distributed among the computing system 206, the data store 210 and the onboard vehicle systems 202, 208. In addition, the functions carried out by these components may be distributed among various programming structures. As noted, the functional modules may provide functionality so that the xVDS framework 300 may be independent of operating-system specific, protocol specific, communication specific, on-board vehicle system specific, and other non-vehicle application type code. Each of these functional modules may supply a given function for the framework. In the description of the functional modules that follow, each module carries out a tailored function. It should be noted, however, that these functional modules are not limited to a single program structure, but the given function may be carried out by and/or integrated with other functions in one or more program structures.

The command-map module 316 may generate and maintain a map within the access-layer application 308. In making the map, the command-map module forms relationships and associations between one or more functions of the vehicle applications 304, the system extensions 302, and/or the user interface extensions 306. In doing so, the command-map module 316 may make the functions of each of these components available to each of the other functional modules. The command-map module 316 may be called by other functional modules to locate and invoke the functions registered in the map.

The system-extension-manager module 320 includes logic for managing the execution of the system extensions 302 for the access-layer application 308. Managing the execution of the system extensions 302 may include (i) loading one or more of the system extensions 302 into memory upon being called or when invoked by the access-layer application 308; (ii) initializing the system extensions 302, which, for example, can include abstracting class libraries and objects from the invoked system extensions 302; (iii) shutting-down and unloading the system extensions 302 when being replaced. obsoleted, or otherwise not needed; and (iv) reporting the status of the system extensions 302 to the other functional modules, the vehicle applications 304, the operating system, and the on-board vehicle systems 202, 208.

Akin to the system-extension-manager module 320, the vehicle-application-manager module 318 includes logic for managing the execution of the vehicle applications 304 for the access-layer application 308. Managing the execution of the vehicle applications 304 may include loading one or more of the system extensions 302 and/or vehicle applications 304 into memory upon being called or when invoked by the access-layer application 308 through data-driven automation or some type of user interaction.

In addition, the managing the execution of the vehicle applications 304 may include initializing class libraries, objects and other parameters abstracted from the invoked system extensions 302 and vehicle applications 304. Further, the vehicle-application-manager module 318 may provide logic for shutting-down and unloading the system extensions 302 when they are being replaced, obsoleted, or otherwise not needed; and reporting the status of the system extensions 302 and the vehicle applications 304 to the other functional modules, the vehicle applications 304, the operating system, and the on-board vehicle systems 202, 208.

The data-store-manager module 322 includes logic for managing the storage of parameters passed between the vehicle applications 304 and the onboard vehicle systems 202, 208. This includes task and device management to maintain current and historical states of the passed parameters. To carry out such management, the data-storage-manager module may interact with the data store 310 via calls with the operating system.

The communication-manager module 324 includes logic for managing communication between the vehicle applications 304 and the on-board vehicle systems 202, 208. The communication-manager module 324 provides a protocol and platform independent method for establishing such communications. As a manager, communication-manager module 324 provides or invokes routines to set-up, maintain and tear down these communications between the vehicle applications 304 and the on-board vehicle systems 202 and/or 208.

To carry out its management function, the communication-manager module 324 may include logic for determining from a host of available communication protocols (e.g., j1708, CAN I and II, etc.) specific communication protocols to communicate with any of the given vehicle controllers of the on-board vehicle systems 202, 208. In addition, the communication-manager module 324 may interface with the communication framework and the communication system 104 (FIG. 1) to provide the parameters to be passed in a format coinciding with the communication system 104. For example, the communication-manager module 324 may provide to the communication framework j1708 code encapsulated in IEEE 802.11 wireless format for communication across the W1 and/or W2 networks. The communication-manager module 324 may manage and perform other communication functions for setting-up, maintaining and tearing down communications as well.

The data-manipulation-manager module 326 includes logic for managing format conversions of the parameters passed between the vehicle applications 304 and the on-board-vehicle systems 202, 208. Given the parameters may be diagnostic and/or telematic information and/or executable code generated and exchanged among differing platforms (i.e., the computing system 206, the communication networks W1 and W2, the data store, the on-board vehicle systems 202, 208, etc.), the form of the parameters may differ depending on where it resides.

For instance, when residing in the on-board vehicle systems 202, 208, the parameters can be raw diagnostic information generated by one or more of the vehicle controllers, such as real-time measurements of oil-pressure. These measurements may be provided as a data-stream having a binary, hexadecimal, ASCII or other format. The vehicle application for this diagnostic information, however, contains a graphical user interface displaying an oil-pressure gauge having graduations in pounds per square inch.

The data-manipulation-manager module 326 may perform a format conversion of the raw diagnostic information so that the vehicle application can receive diagnostic information in a compatible format, such as pound per square inch. This may relieve the vehicle applications 304 from performing such conversion. Alternatively, data-manipulation-manager module 326 may provide one or more interim format conversions; leaving the vehicle applications 304 to perform its own conversions. The data-manipulation-manager module 326 may manage and perform other format conversions as well.

The user-interface-manager module 328 includes logic for managing the execution of the user-interface extensions 306 for the access-layer application. Some of the functions carried out by the user-interface-manger module 328 to manage the execution of user-interface extensions 306 may include (i) loading one or more of the user-interface extensions 306 into memory upon being called or when invoked by the access-layer application 308; (ii) initializing the user-interface extensions 306, which, for example, can include abstracting class libraries and objects from operating system and the user-interface extensions 306; (iii) shutting-down and unloading the user-interface extensions 306 when being replaced, obsoleted, or otherwise not needed; and (iv) reporting the status of the user-interface extensions 306 to the other functional modules, the vehicle applications 304, the operating system, and the on-board vehicle systems 202, 208.

The modular approach provided by the functional modules of the xVDS framework 300 may allow full customization of vehicle applications, without the expense and inflexibility of platform and protocol specific software. Functional modules can be added, replaced and remove to allow for algorithms, settings and other information to be added, or removed. Further, the xVDS framework 300 may provide data-driven operation, which allows the application developer to concentrate design and implementation efforts on the business requirements of the application instead of spending coding time on vehicle-interaction. By using a thin Layer construct, framework becomes isolated from operating differences, which may allow for ease of porting to differing platforms.

As noted, the system extensions may allow functionality to be added at any time, without modifying (or revalidating) the operating system and or the existing xVDS framework 300. The system extensions 302 may be added or removed based upon the amount and type of processing required on the target platform. For example, a computing system that records vehicle information for later review doesn't need to carry the weight of the full implementation. Such a system, however, could be scaled to process and respond to certain conditions by adding the appropriate system extensions and vehicle application module(s).

In view of the wide variety of embodiments that can be applied, it should be understood that the illustrated embodiments are exemplary only, and should not be taken as limiting the scope of the following claims. For instance, in the exemplary embodiments described herein include on-board vehicle systems and other vehicle mounted devices may include or be utilized with any appropriate voltage source, such as a battery, an alternator and the like, providing any appropriate voltage, such as about 12 Volts, about 24 Volts, about 42 Volts and the like.

Further, the embodiments described herein may be used with any desired system or engine. Those systems or engines may comprises items utilizing fossil fuels, such as gasoline, natural gas, propane and the like, electricity, such as that generated by battery, magneto, solar cell and the like, wind and hybrids or combinations thereof. Those systems or engines may be incorporated into other systems, such as an automobile, a truck, a boat or ship, a motorcycle, a generator, an airplane and the like.

In the embodiments described above, the vehicle-interactive system includes computing systems, controllers, and other devices containing processors. These devices may contain at least one Central Processing Unit (“CPU”) and a memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the described methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It should be understood that the exemplary embodiments are not limited to the above-mentioned memories and that other platforms and memories may support the described methods.

Exemplary embodiments have been illustrated and described. Further, the claims should not be read as limited to the described order or elements unless stated to that effect. In addition, use of the term “means” in any claim is intended to invoke 35 U.S.C. §112, ¶ 6, and any claim without the word “means” is not so intended.

What is claimed is:

1. A vehicle information system comprising:
a computing system adapted to run an operating system and a plurality of applications,
at least one vehicle application operable to provide policy processing of at least one parameter, the at least one vehicle application being executable by the computing system;
an access-layer application executable by the computing system, the access-layer application having a first interface adapted to communicate with the vehicle application, and a second interface adapted to communicate with the operating system,
a vehicle-application database operable to house information for processing at least one parameter passed between first and second interfaces, the access-layer application operable obtain from the vehicle-application database the information for processing the at least one parameter, and operable to process the at least one parameter as a function of the information obtained from the vehicle-application database so as to pass the processed at least one parameter between the first and second interfaces in a form commensurate with the first and second interfaces; and
a communication adapter operable to pass the at least one parameter between the second interface and the vehicle controller.

2. The vehicle information system as recited in claim 1, wherein the information houses in the vehicle-application database comprises information for encoding and decoding the at least one parameter passed between the first and second interfaces.

3. The vehicle information system as recited in claim 1, wherein the second interface comprises an vehicle-controller-abstraction interface, and wherein the vehicle-controller-abstraction interface abstracts from the vehicle controller a message protocol used by the vehicle controller, thereby allowing the access-layer application to be vehicle-controller independent.

4. The vehicle information system as recited in claim 1, wherein the second interface comprises an operating-system-abstraction interface, and wherein the operating-system-abstraction interface abstracts operating system and computing system parameters, thereby allowing the access-layer application to be operating-system independent.

5. The vehicle information system as recited in claim 1, wherein the first interface comprises an client-application-abstraction interface, and wherein the client-application-abstraction interface abstracts client application parameters, thereby allowing the access-layer application to be client-application independent.

6. The vehicle information system as recited in claim 5, wherein the client application parameters comprise client language used for displaying and inputting the information in the vehicle-application database.

7. The vehicle information system as recited in claim 1, wherein the access-layer application comprises a third interface, wherein the third interface comprises a vehicle-programming-abstraction interface, and wherein the vehicle-programming-abstraction interface abstracts programming parameters used for programming the vehicle controller.

8. The vehicle information system as recited in claim 1, further comprising an operating system socket interface for local and remote communication with the operating system.

9. The vehicle information system as recited in claim 1, wherein the vehicle-application database comprises:
vehicle information associated with the vehicle controller;
message information for querying and extracting information from the vehicle controller;
datapoints for interpreting, organizing, and processing information from the vehicle controller;
trouble codes for supporting diagnostics of the vehicle controller;
fault groups for organizing and supporting the trouble codes; and
scaling functions for support formatting and retrieval of values for the vehicle application.

10. The vehicle information system as recited in claim 9, wherein the datapoints, trouble codes, and fault group are grouped into logical category groups.

11. A vehicle information system comprising:
a computing system adapted to run an operating system and a plurality of applications,
at least one vehicle application operable to provide policy processing of at least one parameter, the at least one vehicle application being executable by the computing system;
an access-layer application executable by the computing system, the access-layer application comprising:
at least one logic module for processing the at least one parameter;
an application program interface adapted to provide a common interface for any of the at least one vehicle application and adapted to interface with the at least one logic module, and
an operating-system-abstraction interface adapted to interface with the at least one logic module and the operating system, the operating-system-abstraction interface abstracting operating system and computing system parameters, thereby allowing the access-layer application to be operating-system independent, and
a vehicle-application database operable to house information for processing at least one parameter passed between application program interface and operating-system-abstraction interface, the access-layer application operable obtain from the vehicle-application database the information for processing the at least one parameter, and operable to process the at least one parameter as a function of the information obtained from the vehicle-application database so as to pass the processed at least one parameter between the application program interface and operating-system-abstraction interface in a form-commensurate with the application program interface and operating-system-abstraction interface; and
a communication adapter operable to pass the at least one parameter between the second interface and the vehicle controller.

12. The vehicle information system as recited in claim 11, wherein the information housed in the vehicle-application database comprises information for encoding and decoding the at least one parameter passed between the application program interface and operating-system-abstraction interface.

13. The vehicle information system as recited in claim 11, wherein the operating-system-abstraction interface comprises an vehicle-controller-abstraction interface, and wherein the vehicle-controller-abstraction interface abstracts from the vehicle controller a message protocol used by the vehicle controller, thereby allowing the access-layer application to be vehicle-controller independent.

14. The vehicle information system as recited in claim 11, wherein the application program interface comprises an client-application-abstraction interface, and wherein the client-application-abstraction interface abstracts client application parameters, thereby allowing the access-layer application to be client-application independent.

15. The vehicle information system as recited in claim 14, wherein the client application parameters comprise client language used for displaying and inputting the information in the vehicle-application database.

16. The vehicle information system as recited in claim 11, wherein the access-layer application comprises a third interface, wherein the third interface comprises a vehicle-programming-abstraction interface, and wherein the vehicle-programming-abstraction interface abstracts programming parameters used for programming the vehicle controller.

17. The vehicle information system as recited in claim 11, further comprising an operating system socket interface for local and remote communication with the operating system.

18. The vehicle information system as recited in claim 11, wherein the vehicle-application database comprises:
vehicle information associated with the vehicle controller;
message information for querying and extracting information from the vehicle controller;
datapoints for interpreting, organizing, and processing information from the vehicle controller;
trouble codes for supporting diagnostics of the vehicle controller;
fault groups for organizing and supporting the trouble codes; and
scaling functions for support formatting and retrieval of values for the vehicle application.

19. In a vehicle information system having a computing system adapted to run an operating system and a plurality of applications, the plurality of applications, a computer readable medium comprising:
at least one vehicle application operable to provide policy processing of at least one parameter, the at least one vehicle application being executable by the computing system;
an access-layer application executable by the computing system, the access-layer application having a first interface adapted to communicate with the vehicle application, and a second interface adapted to communicate with the operating system,
a vehicle-application database operable to house information for processing at least one parameter passed between first and second interfaces, wherein when executed by the computing system the access-layer application is operable to (i) obtain the at least one parameter at the second interface from the vehicle controller via a communication adapter, (ii) obtain from the vehicle-application database the information for processing the at least one parameter, and (iii) process the at least one parameter as a function of the information obtained from the vehicle-application database so as to pass the processed at least one parameter between the first and second interfaces in a form commensurate with the first and second interfaces.

20. The vehicle information system as recited in claim 19, wherein the vehicle-application database comprises:
vehicle information associated with the vehicle controller;
message information for querying and extracting information from the vehicle controller;
datapoints for interpreting, organizing, and processing information from the vehicle controller;
trouble codes for supporting diagnostics of the vehicle controller;
fault groups for organizing and supporting the trouble codes; and
scaling functions for support formatting and retrieval of values for the vehicle application.
